(19) United States
(12) Patent Application Publication
(10) Pub. No.: US 2004/0164069 A1
(43) Pub. Date: Aug. 26, 2004

(54) Heating element for igniting a pyrotechnical charge

(75) Inventors: Markus Forsthuber, Oyenhausen (AT); Robert Hatzl, Eggendorf/Siedlung Maria Theresia (AT)

Correspondence Address: THE FIRM OF KARL F ROSS, 5676 RIVERDALE AVENUE, PO BOX 900, RIVERDALE (BRONX), NY, 10471-0900, US

(73) Assignee: HIRTENBERGER-SCHAFFLER AUTOMOTIVE ZUNDER GES. m.b.H.

(21) Appl. No.: 10/784,042

(22) Filed: Feb. 20, 2004

(30) Foreign Application Priority Data
Feb. 26, 2003 (AT) A283/2003

(51) Int. Cl. H05B 3/16

(52) U.S. Cl. 219/543; 219/548

(57) ABSTRACT

A heating element for igniting a pyrotechnical charge, for example a charge of an air bag for a motor vehicle. The resistance strip on the base body extends between contact surfaces formed on the base body on opposite sides thereof. The junctions of the resistance strip with the contact surfaces are offset from conductive bridges between the terminal pins and the contact surfaces and the resistance strip may have a meander pattern or can extend diagonally between the contact surfaces.

### FIELD OF THE INVENTION

Our present invention relates to a heating element for the ignition of pyrotechnical charges and, more particularly, to a heating element for firing the charge of an air bag or like device in a motor vehicle. In particular the invention relates to a heating element of the type where a resistance strip is provided with contacts at opposite ends and through which an electric current can be passed to fire a charge in the vicinity of that heating element.

### BACKGROUND OF THE INVENTION

It is known, in the formation of igniters for pyrotechnical charges, such as the charge of an “air bag” or the like, to provide a resistance strip as part of the heating element which can extend between two contact surfaces running transverse to the resistance strip at the end thereof. Connecting elements which can in part be disposed on the contact surfaces can form electrical bridges to contact pins or the like.

The connecting elements thus form electrical conductors between the contact surfaces and the contact pins and in the past have been disposed along those contact surfaces at substantially the same locations as were formed by the junctions of the contact surfaces of the resistance strip.

The heating elements were formed by layering techniques whereby, for example, the resistance strip usually was deposited so that it engaged the contact surfaces at each end at the middle of that contact surface. The connecting elements, in turn, which were joined to the contact pin, also usually were applied to the contact surfaces at the middle thereof. The resistance strip usually extended along the connecting line between midpoints of the contact pins.

The electrical connection between each contact pin and the respective contact surface of the heating element could be formed by means of a solder connection, an electrically conductive adhesive or wire bonding. When wire bonding was used, it generally was directed by a synthetic resin mass or so-called “glob-top”. The process involved in making the heating element could result in a flow of the solder paste, adhesive or glob-top onto the igniter bridge formed by the resistance strip. That of course could result in a change in the electrical characteristics of the resistance bridge (e.g. the electrical resistance, ignition sensitivity) so that the heating element could be made completely unusable or largely unreliable.

### OBJECTS OF THE INVENTION

It is, therefore, the principal object of the present invention to provide an improved heating element or igniter for the purposes described which is free from these drawbacks.

More specifically it is an object of the invention to provide an improved heating element for igniting a pyrotechnical charge which is not damaged by application of the conductive material bridging between the terminal pins and the conductive strips of that heating element.

Yet another object of the invention is to provide an improved heating element which is more reliable than earlier ignition devices for pyrotechnical charges such as the safety bag of a motor vehicle.

### SUMMARY OF THE INVENTION

These objects are attained, in accordance with the invention in a heating element for igniting a pyrotechnical charge which comprises:

a base body;

a resistance strip on the base body and extending from one side of the base body to an opposite side thereof;

respective contact surface formed on the base body at each of the sides and making electrical contact with the resistance strip at each side; and

respective conductive elements electrically connecting each of the contact surfaces with an electrical terminal, each of the conductive elements contacting the respective contact surface at a location offset from a location at which the resistance strip contacts the respective contact surface.

According to the invention, one of the conductive elements contacts the respective contact surface at a location offset from a location at which the resistance strip contacts the respective contact surface at one of the sides in a direction opposite from that at which the other of the conductive elements is offset from a location at which the resistance strip contacts the other of the contact surfaces.

In the system of the invention, the junctions of the resistance strips with the contact areas at each end of the device and the junctions of the conductive elements with those contact surfaces are offset from one another. The resistance strip according to the invention no longer lies in a line connecting the midpoints of the contact pins but rather the junctions between the resistance strip and the contact surfaces are to the greatest extent possible offset from this connecting line. The electrical connection of the contact strip with the pins can thus be effected without damage or adversely affecting the resistance strip.

There is no danger in making the electrical connection that the resistance strip will be affected in any way. When the junctions of the resistance strips with the contact surfaces are offset in opposite directions at both ends of the heating elements, there is the additional advantage that longer resistance paths can be obtained. These paths can run along a diagonal or be of a meander shape.

### BRIEF DESCRIPTION OF THE DRAWING

The above and other objects, features, and advantages will become more readily apparent from the following description, reference being made to the accompanying drawing in which:

FIG. 1 is a plan view in highly diagrammatic form of a heating element in accordance with prior art principles;

FIG. 2 is a view similar to FIG. 1 showing one embodiment according to the invention;

FIG. 3 is another view similar to FIG. 1 but illustrating an embodiment in which the resistance strip runs diagonally;

FIG. 4 is a view similar to the preceding views but showing an embodiment in which the resistance strip has a meander pattern; and

FIG. 5 is a cross sectional view through a heating element according to the invention.

### SPECIFIC DESCRIPTION

In a prior art heating element, a resistance strip 2 is applied to a base body 1. The ends of the resistance strip 2 terminate at contact areas 3 which are here shown to be rectangular and to extend transversely to the resistance strip. The junctions between the resistance strip 2 and each of the contact areas is located substantially at the center of the contact strip.

Externally of the body 1 and the contact areas 3, contact pins 4 are provided to apply the ignition voltage to the heating element when the pyrotechnic charge is to be ignited.

In the prior art configuration, each contact pin 4 is connected with the respective contact area 3 by a conductive connecting element 5 which can be a small pad of solder and which bridges the pin 4 and the contact area 3 partly overlapping both. The contact bridges 5 are located generally at the centers of the respective contact areas 3 and practically at the junctions of the resistance strip 2 therewith.

During the solder application, the drawbacks previously described with respect to alteration of the properties of the resistance strip 2 can thus arise.

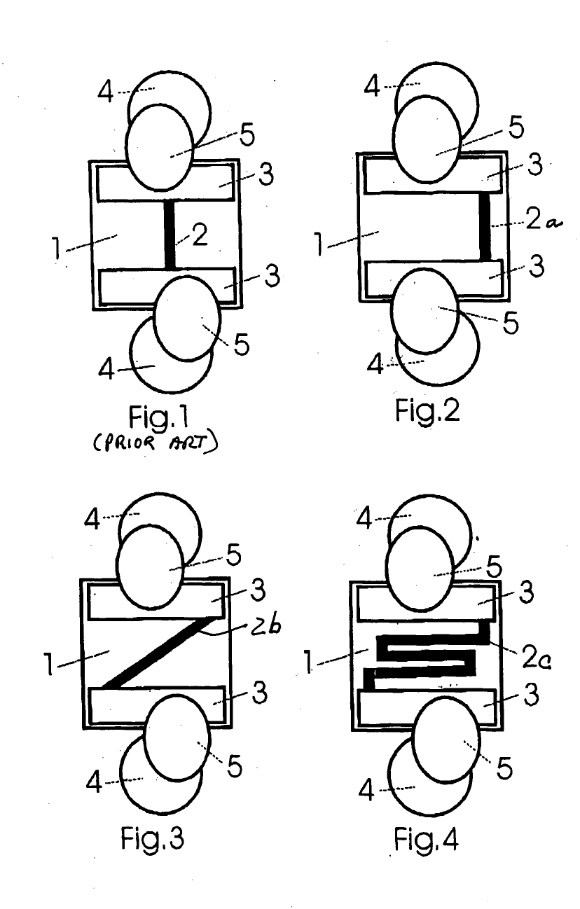

According to the invention and as shown diagrammatically in FIG. 2 the junction regions of the resistance strip 2a and the respective contact areas can be significantly offset from the regions at which the contact bridges engage the strips 3. In that case, even if an excessive amount of solder is applied, there is no danger that the solder will flow onto the resistance strip 2a and result in a defective igniter or a reject. In this embodiment the resistance strip 2a is perpendicular to the contact areas 3 and is parallel to the position of the resistance strip 2 in FIG. 1.

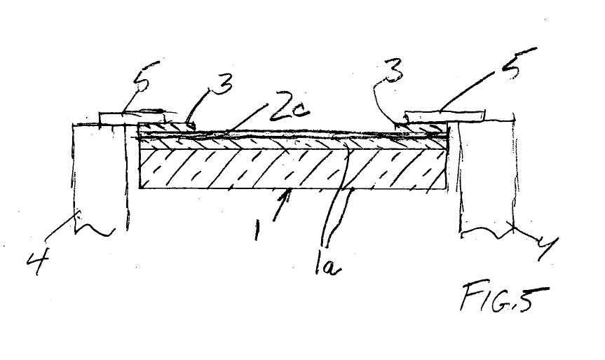

In the embodiment of FIG. 3, however, the junction between the resistance strip 2b and the contact areas 3 are offset in opposite directions on the two contact areas and thus the strip 2b runs diagonally. In this case the resistance strip 2b is longer than in the embodiment of FIG. 2 which is of advantage in many ignition applications. If the resistance strip is to be still longer, a meander configuration can be provided as shown at 2c in FIG. 4. Here the resistance strip 2c joins the contact regions 3 at opposite ends thereof while the solder bridges 5 overlap the contact regions near the centers thereof.

FIG. 5 shows pins 4, the contact bridges 5 and the contact regions 3, the latter being applied to the heating element by layer technology. The resistance strip is shown at 2c in FIG. 5 and the body 1 is also shown to be built up by layer technology from the layers 1a.

We claim:

1. A heating element for igniting a pyrotechnical charge, comprising:
a base body;
a resistance strip on said base body and extending from one side of said base body to an opposite side thereof;
respective contact surface formed on said base body at each of said sides and making electrical contact with said resistance strip at each side; and
respective conductive elements electrically connecting each of said contact surfaces with an electrical terminal, each of said conductive elements contacting the respective contact surface at a location offset from a location at which the resistance strip contacts said respective contact surface.

2. The heating element defined in claim 1 wherein one of said conductive elements contacts the respective contact surface at a location offset from a location at which the resistance strip contacts said respective contact surface at one of said sides in a direction opposite from that at which the other of said conductive elements is offset from a location at which the resistance strip contacts the other of said contact surfaces.

3. The heating element defined in claim 2 wherein said resistance strip extends in a meander pattern between said contact strips.

4. The heating element defined in claim 2 wherein said resistance strip extends diagonally between said contact strips.
